(19) United States
(12) Patent Application Publication
(10) Pub. No.: US 2026/0288691 A1
(43) Pub. Date: Sep. 24, 2026

(54) COMPACT HASH TABLE

(71) Applicant: International Business Machines Corporation, Armonk, NY (US)

(72) Inventor: Ian Richard Finlay, Uxbridge (CA)

(21) Appl. No.: 19/083,663

(22) Filed: Mar. 19, 2025

(51) Int. Cl. G06F 16/22

(52) U.S. Cl. CPC G06F 16/2255

(57) ABSTRACT

A computer-implemented method includes assigning a bit of a segmented bitmap to at least one tuple. A buffer association to the bit is determined and a buffer is created when no buffer is associated with the bit. A key and payload of the at least one tuple is allocated to the buffer. The method determines if the buffer is full when the bit is associated with a buffer and responds to the buffer not being full by allocating the key and payload of the at least one tuple into the buffer.

### BACKGROUND

The present invention generally relates to hash tables, and more specifically, to a dynamically built hash table that is suited for single pass hash table builds.

Hash joins are a common operator in business intelligence (BI) queries. Hash joins involve many random accesses to hash tables. Conventional systems do partitioned joins by dividing the join hash table into partitions, so that lookups are focused on small data structures, which will fit better in cache. But below a threshold on the hash table size, a non-partitioned join is more efficient because it avoids the costs of partitioning.

### SUMMARY

Embodiments of the present invention are directed to a computer-implemented method for constructing and maintaining a compact hash table. A non-limiting example of the computer-implemented method includes assigning a bit of a segmented bitmap to at least one tuple. A buffer association to the bit is determined and a buffer is created when no buffer is associated with the bit. A key and payload of the at least one tuple is allocated to the buffer. The method determines if the buffer is full when the bit is associated with a buffer and responds to the buffer not being full by allocating the key and payload of the at least one tuple into the buffer.

Embodiments of the present invention are also directed to a computer readable medium for storing instructions to implement the method, and a system for implementing the method.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts one exemplary cloud computing system configured to implement the system and method according to one embodiment;

FIG. 2 depicts a process for constructing a compact hash table according to one example; and

FIG. 3 depicts a process for constructing a dynamic compact hash table according to another example.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Computing environment 100 contains an example of an environment for the execution of at least some of the computer code involved in performing the inventive methods, such as constructing and maintaining a compact hash table at block 150. In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130, Public Cloud 105 includes gateway 140, Cloud orchestration module 141, host physical machine set 142, virtual machine set 143, and container set 144.

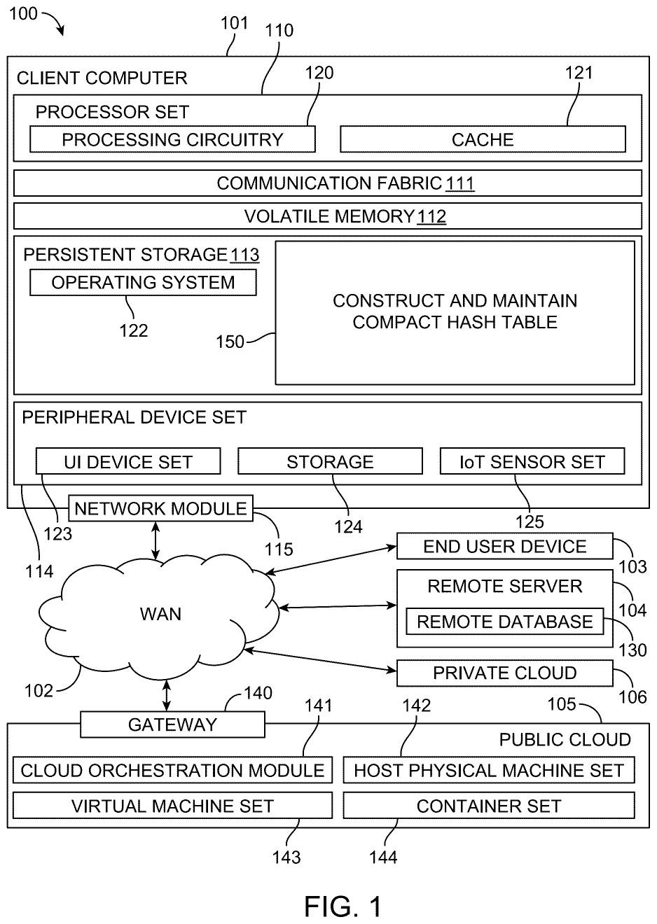

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 141. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Turning now to an overview of technologies that are more specifically relevant to aspects of the invention, a hash table (HT) is made up of two parts: an array (the actual table where the data to be searched is stored) and a mapping function, known as a hash function. With a hash table, any value may be used as an index, such as a floating-point value, a string, another array, or even a structure as the index. This index is called the key, and the contents of the array element at that index is called the value. Therefore, an HT is a data structure that stores key/value pairs and can be quickly searched by the key. The hash function is a mapping from the input space to the integer space that defines the indices of the array. The hash function provides a way for assigning numbers to the input data such that the data can then be stored at the array index corresponding to the assigned number.

A hash join is an example of a join process and is used in the implementation of a relational database management system (DMS). The task of a join process is to find, for each distinct value of the join attribute, the set of tuples in each relation which have that value. Hash joins require an equijoin predicate (a predicate comparing values from one table with values from the other table using the equals operator ‘=’).

An inner join creates a new result table by combining column values of two tables (e.g., table1 and table2) based upon the join-predicate. The query compares each row of table1 with each row of table2 to find all pairs of rows which satisfy the join-predicate. When the join-predicate is satisfied, column values for each matched pair of rows of A and B are combined into a result row.

Non-partitioned hash joins perform a join between two inputs by building a single HT on one of the inputs, and performing lookups into this HT with the join columns of the other input. Conventionally, the HT for a non-partitioned join is typically built in one of two ways: built serially with a single thread, and built in parallel using latches on the HT buckets. Both ways result in slow HT builds. Further, conventional methods for building HTs focus on the case of provably n:1 HTs (when there is an index enforcing that each key has at most 1 matching payload), and require a large memory allocation for the case that such an index is not present, due to fill factor overheads from linear probing.

A classic hash join algorithm for an inner join of two relations proceeds as follows. First prepare a HT of the smaller relation. The HT entries include the join attribute and its row. Because the HT is accessed by applying a hash function to the join attribute, it is quicker to find a given join attribute's rows by using this table than by scanning the original relation. Once the HT is built, the larger relation is scanned and the relevant rows from the smaller relation are found by looking in the HT. The first phase is usually called the “build” phase, while the second is called the “probe” phase. Similarly, the join relation on which the HT is built is called the “build” input, whereas the other input is called the “probe” input. The process requires that the smaller join relation fits into memory, which is sometimes not the case. A simple approach to handling this situation carries out a lazy partitioning process, proceeding as follows:
1. For each tuple r in the build input R:
   a. Add r to the in-memory HT
   b. If the size of the HT equals the maximum in-memory size:
      i. Record the hash code at the midpoint in the in-memory HT, and spill ½ of the HT to temporarily storage (typically disk)
2. For each tuple s in the probe input S:
   a. If the hash code is greater than or equal to the hash codes in the spilled portions of the HT, spill the tuple s to temporary storage (typically disk) for the next processing step for spilled HT processing
   b. Else, probe the in-memory portion of the HT and add matching join tuples to the output relation
3. Until all spilled HT portions have been processed:
   a. Reset the HT and load a portion of the spilled HT segments to fill up to the maximum in-memory size with a range of hash codes from all spilled HT segments.
   b. For each spilled tuple s for this processing step iteration:
      i. If the hash code is greater than or equal to the hash codes in the portions of the HT that are still spilled, re-spill the tuple s to temporary storage (typically disk) for the next processing iteration for the remaining spilled HT segments
      ii. Else, probe the in-memory portion of the HT and add matching join tuples to the output relation

Existing compact hash table structures represent an improvement over previous techniques, but are limited in that all of the content included in the hash table must be available before the hash table can be constructed. In addition, the existing compact hash table techniques require some form of temporary storage, or the ability to re-read the data that was to be placed into the hash table, in order for the hash table to be constructed. As a result, previous compact hash table techniques were not suitable for indeterminate hash table processing for cases like “group by”, or similar dynamic hash table processing used in standard hash table implementations. By way of example, linked list implementations of hash tables and full sized linear probe hash tables include large amounts of unoccupied space and over-allocations preventing compact hash table techniques from being viable.

Embodiments of the disclosure contained herein generally improve upon previous compact hash table techniques by providing a dynamically built compact hash table that is suitable for single pass hash table builds and operations. This allows the compact hash table to be usable in multiple additional scenarios and for additional functions, thereby providing a broader general usage of the compact hash table.

Turning now to an overview of the aspects of the invention, one or more embodiments of the invention address the above-described shortcomings of the prior art by providing an improved compact hash table with a reduced storage requirement. In some examples, the storage requirement is reduced by at least 2×.

One or more of the embodiments limits memory moves to within a single segment, allowing choices of organization of keys and payloads within a segment to be open to various implementation choices (e.g. insert sort, sparse insert, post sort, unordered probe-time search, etc.).

In one or more of the embodiments temping stages used in previous hash table operations can be either limited or localized, and the embodiments allow for duplicate handling and performing aggregation as tuples arrive and as duplicates are accumulated for later vector processing of aggregates.

One or more of the embodiments requires only 2-bits or less per virtual hash table entry, whereas prior art systems require a full key and payload size and/or can have challenges in linked list and associated processing.

In one or more of the embodiments, resizing of the hash table is reduced or eliminated due to the oversized nature of the virtual hash table, and due to the ability of the embodiments to dynamically grow the segment buffers up to and even beyond the entry limits of the segment.

In one or more embodiments, the compact hash table can cycle, or virtualize, segment buffers to achieve a near infinite hash table size.

Compact hash tables can generally be conceived as a “virtual hash table” in the form of a bitmap. The compact hash table provides the access counts and offsets, pointers or references for locating the hash table content in a compact array/matrix that contains the main data for the hash table.

The bitmap itself is a combination of bit sets that represent occupied hash table cells (rows), and a pointer or reference to the location of the current hash table segment. Often, the segments are native CPU sized words or long words (e.g. 64-bit words in a Db2 Linux, Unix, Windows implementation, with 64 potential entries in each cell). In order to accommodate this sizing, the hash table/bitmap is typically oversized at roughly an 8:1 ratio, allowing the hash table to operate with near 0 collisions.

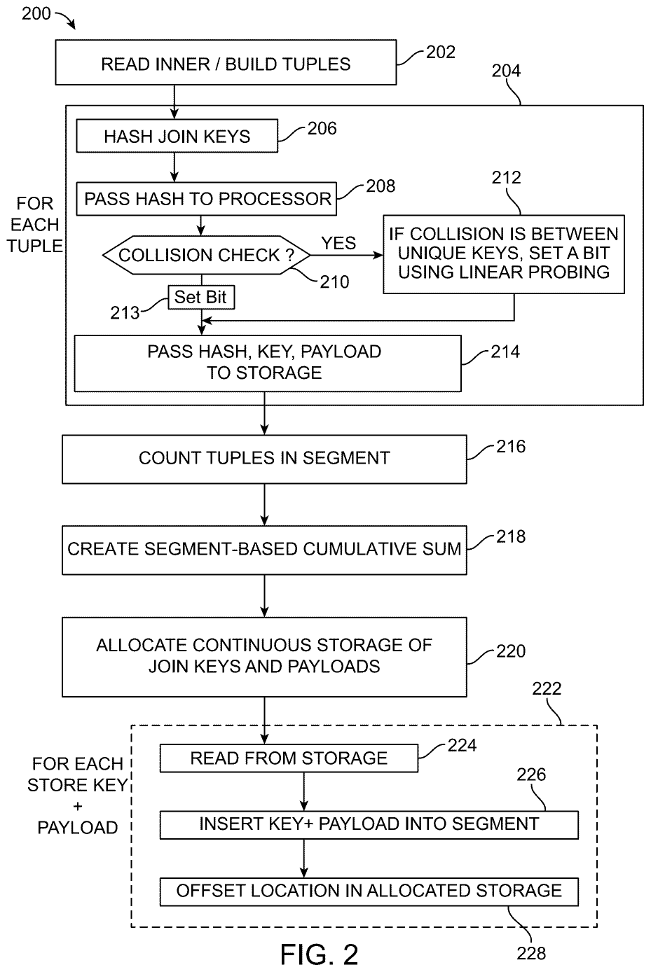

With continued reference to FIG. 1, FIG. 2 illustrates an exemplary process 200 used to generate conventional compact hash tables. Initially the process 200 reads the inner/build tuples in a read inner/build tuples step 202.

After reading the tuples, a Collision Detection and Tuple Storage process 204 is operated for each tuple. Within the collision detection and tuple storage process 204, the process 200 initially hashes the join keys in a hash join keys step 206. The hashed join keys are passed to a processor in a pass hash to processor step 208. The processor operates a Collision Test 210 to test if the bit at the Hash Code is set and determine if the tuple includes a hash collision with one or more previously processed unique keys. When a collision between hashed unique keys is detected, the collision detection and tuple storage process 204 uses linear probing to set a bit in a bit set step 212 and continues to pass hash, key, payload to storage step 214. When no collision between unique keys is detected, the collision detection and tuple storage process 204 uses the bit set process 213 to set the tested bit of process 210 in the bit set, indicating a unique key has hashed to this bit location and continues to pass hash, key, payload to storage step 214. The payload of a tuple refers to any additional columns of interest for the tuple. The hash, key and payload of each tuple is passed to a storage method in a pass hash, key, payload to storage step 216 and ends process 204 for the current tuple.

After operating the collision detection and tuple storage process 204 ends for each tuple, the process 200 proceeds to count the total number of tuples in each segment in a count tuples in segment step 216.

Once counted, the process 200 creates a segment-based cumulative sum of the tuples in a given segment in a create cumulative sum step 218, and allocates continuous storage of the join keys and payloads in an allocate storage step 220.

The process 200 then generates the compact hash table by operating a sub-process 222 for each stored key and payload from process 214, by reading the stored tuples in a read from storage step 224, inserting the key and payload into a segment of the compact hash table in an insert step 226, and offsetting the location in the allocated storage in an offset memory location step 228.

Once completed for each stored key and payload, the compact hash table is constructed. This process 200 requires full knowledge of the content of the hash table during the construction of the hash table.

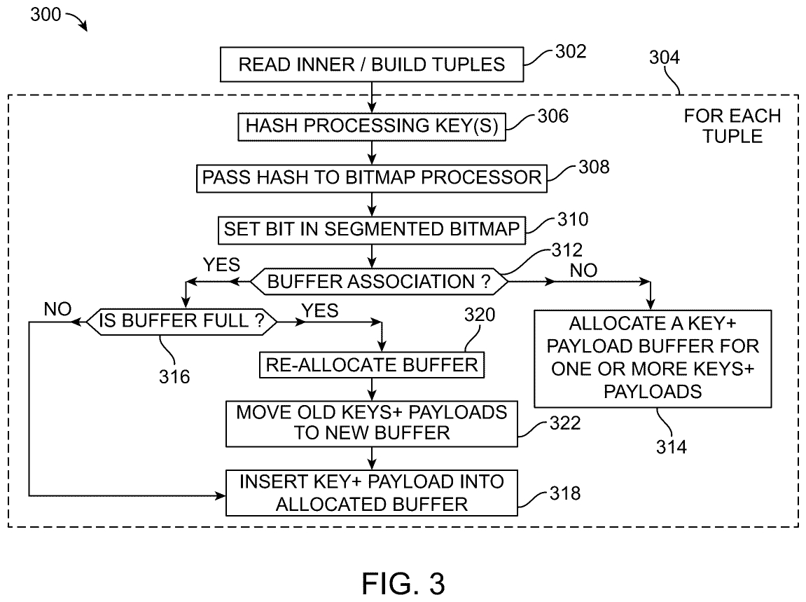

In order to allow the compact hash table to be dynamically updated with new tuples, the process 200 can be modified. With continued reference to FIGS. 1 and 2, FIG. 3 illustrates an improved allocation process 300 for allocating tuples in a compact hash table. Initially, the allocation process 300 reads the inner/build tuples in a read inner/build tuples step 302.

After reading the tuples, the process 300 begins a tuple allocation sub-process 304 that is operated for each tuple. The allocation sub-process 304 initially hashes the processing key(s) in a hash step 306. The hash is then passed to a bitmap processor in a pass hash to bitmap processor step 308 and a bit is set for the tuple in the segmented bitmap in a set bit in segmented bitmap step 310.

After setting the bit, the allocation sub-process 304 checks to see if a buffer is already associated with the bit in a buffer association check 312. When no buffer is already associated with the bit, the sub-process 304 allocates a key and payload buffer for one or more of the keys and payloads in an allocate key and payload step 314, and the sub-process 304 inserts the key and payload into the buffer in an insertion step 318.

When the buffer association check 312 identifies a buffer associated with the bit, the sub-process 300 checks to see if the buffer is full in an is buffer full check 316. When the buffer is not full, the sub-process 304 inserts the key and payload into the associated buffer in an insertion step 318.

When the buffer is full, the sub-process re-allocates the buffer in a re-allocate buffer step 320 and moves old keys and payloads to a new buffer in a move step 322. After moving the old keys and payloads, the buffer is no longer full, and the sub-process inserts the key and payload into the buffer using the insertion step 318.

This allocation sub-process 304 allows for new tuples to be added to the compact hash table and allows the compact hash table to be continuously updated (e.g., a dynamic compact hash table). This further allows the temporary storage from the process 200 of FIG. 2 to be omitted by replacing the temporary storage with the bitmap association. Furthermore, linear probing does not cross segments and instead is limited to the entries associated with the particular bitmap segment. This is possible, because the buffer associated with the bitmap segment is no longer limited to the number of entries associated with the bits in the segment and allows each segment to contain all keys and collisions that occur within the segment. By keeping the keys in their original segment, the range of linear probing is limited to just the segment. Without this characteristic, linear probing can continue across multiple segments, negatively impacting performance, and potentially filling the entire hash table, rendering it full, and unable to accept additional unique keys and associated payloads.

Referring generally to the sub-process 304, the process replaces the utilization of a cumulative array index (as in FIG. 2) with a pointer or reference to blocks of tuples. As the inner is processed, a small block is allocated for the “cell” or “segment”, and the tuple is placed in the block. When using an 8:1 fill in factor, and a 64-bit bitmap, a typical implementation will include up to 8 tuples in any given cell. Linear probing is not required to transition to the next cell/segment and can therefore be limited to within a single block and cell/segment.

Additionally, repeated inner key tuples can be stored in close proximity to the original/initial key.

In some examples, sparse inserts use pre-allocation buffers of four or eight entry blocks, placing tuples in their quadrant initially and moving the tuples as needed during fill and/or build steps. One skilled in the art will recognize any number of buffer management organizations and techniques can be employed.

For group by operations, collisions are aggregated and accumulated for aggregation and the buffer can either be postprocess compacted or the sparce-fill characteristic can be used to accelerate probing. A per-block multiplier can, in some examples, be incorporated into the lower bits of the block's pointer (assuming a 64-bit alignment), and adjusted if the block is re-sized.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
assigning a bit of a segmented bitmap to at least one tuple;
determining a buffer association to the bit;
creating a buffer when no buffer is associated with the bit and allocating a key and payload of the at least one tuple to the buffer;
determining if the buffer is full when the bit is associated with a buffer and responding to the buffer not being full by allocating the key and payload of the at least one tuple into the buffer; and
wherein movement of tuples from a first memory location to a second memory location is limited to movement within a segment of the segmented bitmap.

2. The computer-implemented method of claim 1, further comprising responding to the buffer being full by extending the buffer, creating a new buffer, and allocating the key and payload of the at least one tuple to the new buffer.

3. The computer-implemented method of claim 1, wherein each key and payload is implemented as one of an insert sort, a sparse insert, a post sort, or an unordered probe-time search.

4. The computer-implemented method of claim 1, wherein the segmented bitmap includes a plurality of segments and wherein each bit is associated with a segment of the plurality of segments.

5. (canceled)

6. The computer-implemented method of claim 1, wherein assigning the bit of the segmented bitmap to at least one tuple comprises hashing processing keys of the at least one tuple, passing the hash of the process keys to a bitmap processor, and assigning a bit in the segmented bitmap to the hash of the processing keys.

7. The computer-implemented method of claim 1, further comprising generating a hash table defining the segmented bitmap.

8. The computer-implemented method of claim 7, wherein the method is performed without resizing the generated hash table.

9. A computer program product comprising a non-transitory computer readable memory storing instructions for implementing a compact hash table by:
assigning a bit of a segmented bitmap to at least one tuple;
determining a buffer association to the bit;
creating a buffer when no buffer is associated with the bit and allocating a key and payload of the at least one tuple to the buffer; and
determining if the buffer is full when the bit is associated with a buffer and responding to the buffer not being full by allocating the key and payload of the at least one tuple into the buffer; and
wherein movement of tuples from a first memory location to a second memory location is limited to movement within a segment of the segmented bitmap.

10. The computer program product of claim 9, further comprising responding to the buffer being full by re-allocating the buffer, creating a new buffer, and allocating the key and payload of the at least one tuple to the new buffer.

11. The computer program product of claim 9, wherein each key and payload is implemented as one of an insert sort, a sparse insert, a post sort, and an unordered probe-time search.

12. The computer program product of claim 9, wherein the segmented bitmap includes a plurality of segments and wherein each bit is associated with a segment of the plurality of segments.

13. (canceled)

14. The computer program product of claim 9, wherein assigning the bit of the segmented bitmap to at least one tuple comprises hashing processing keys of the at least one tuple, passing the hash of the process keys to a bitmap processor, and assigning a bit in the segmented bitmap to the hash of the process keys.

15. The computer program product of claim 9, further comprising generating a hash table defining the segmented bitmap.

16. The computer program product of claim 15, wherein assigning the bit of the segmented bitmap to the at least one tuple, determining the buffer association to the bit, creating the buffer when no buffer is associated with the bit and allocating the key and payload of the at least one tuple to the buffer, and determining if the buffer is full when the bit is associated with the buffer and responding to the buffer not being full by allocating the key and payload of the at least one tuple into the buffer is performed without resizing the generated hash table.

17. A system comprising:
a processor set and a persistent storage, the persistent storage including code defining instructions for cause the processor to update a compact hash table by;
assigning a bit of a segmented bitmap to at least one tuple;
determining a buffer association to the bit;
creating a buffer when no buffer is associated with the bit and allocating a key and payload of the at least one tuple to the buffer;
determining if the buffer is full when the bit is associated with a buffer and responding to the buffer not being full by allocating the key and payload of the at least one tuple into the buffer;
responding to the buffer being full by re-allocating or otherwise extending the buffer, creating a new buffer, and allocating the key and payload of the at least one tuple to the new buffer; and
wherein movement of tuples from a first memory location to a second memory location is limited to movement within a segment of the segmented bitmap.

18. The system of claim 17, wherein the segmented bitmap includes a plurality of segments and wherein each bit is associated with a segment of the plurality of segments.

19. (canceled)

20. The system of claim 17, wherein assigning the bit of the segmented bitmap to at least one tuple comprises hashing processing keys of the at least one tuple, passing the hash of the process keys to a bitmap processor, and assigning a bit in the segmented bitmap to the hash of the process keys.
